(19) United States
(12) Patent Application Publication
(10) Pub. No.: US 2026/0227535 A1
(43) Pub. Date: Aug. 6, 2026

(54) A METHOD FOR ESTIMATING A NOTIONAL SOURCE WAVEFORM

(71) Applicant: REFLECTION MARINE NORGE AS, Laksevag (NO)

(72) Inventors: Rob Telling, Gatwick, West Sussex (GB); Robert Montgomery Laws, Nottingham (GB); Arash Jafargandomi, Gatwick, West Sussex (GB); Sergio Grion, Surrey (GB)

(21) Appl. No.: 19/147,526

(22) PCT Filed: Jan. 8, 2024
(86) PCT No.: PCT/NO2024/050003

§ 371 Date: Jul. 11, 2025

(30) Foreign Application Priority Data
Jan. 12, 2023 (NO) 20230027

(51) Int. Cl. G01V 1/135; G01D 21/02; G01V 1/00; G01V 1/30

(52) U.S. Cl. CPC G01V 1/135; G01D 21/02; G01V 1/006; G01V 1/303; G01V 2210/1214; G01V 2210/125; G01V 2210/1293; G01V 2210/1423; G01V 2210/144

(57) ABSTRACT

Described herein is a method for deriving at least one notional source waveform for an array comprising at least one marine vibrator, the method comprising: during operation of the at least one marine vibrator, recording data from a first sensor measuring a property related to the wavefield in the fluid surrounding the at least one marine vibrator, during operation of the at least one marine vibrator, recording data from a second sensor coupled to or internal to a radiating surface of the vibrator and measuring a property related to motion of the radiating surface; and jointly inverting the data from the first sensor and the data from the second sensor to recover the at least one notional source waveform for the array. Also described herein is a method for carrying out a seismic survey and a seismic survey apparatus.

The present invention relates to a method for estimating one or more notional source waveforms or acoustic source signatures for a source array, and to a method and apparatus for carrying out a seismic survey using a source array. In particular, the invention relates to use of a joint inversion method for accurately estimating acoustic source signatures for a marine vibrator array and use of this method in a seismic survey.

Seismic surveying techniques represent an effective way to study the earth's subsurface structure. The information obtained from such surveys is of wide scientific interest and can be used to study the make-up and history of the earth, as well as for locating and accessing underground reservoirs of hydrocarbon-based fossil fuels. Marine seismic surveys use acoustic sources, which are configured to emit acoustic energy at selected frequencies to then propagate through the earth's surface and subsurface. The waves are reflected at boundaries between different materials within the subsurface, or are refracted, and travel back towards seismic sensors. The sensors convert the received acoustic signal into an electric signal which is sent to a processor for analysis. The collected signals carry with them information about the subsurface, i.e. the materials either side of the different boundaries, and the positions of the boundaries themselves.

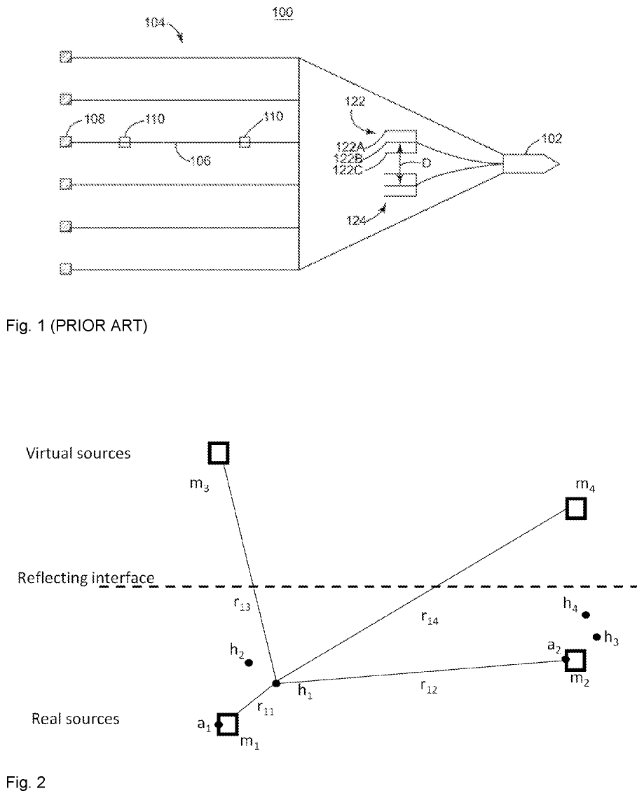

An example of a typical survey setup 100 is shown in FIG. 1, and includes a vessel 102 towing a seismic spread 104 including plural streamers 106 and associated equipment (such as floats 108 at the ends of the streamers). The streamers themselves can be up to 8 km or 9 km in length, or more, and include plural seismic sensors 110 for recording seismic data. In order to survey the sub-surface structure, sensors are generally located either within the one or more streamers which are towed behind a marine survey vessel as shown, and/or are positioned at particular locations on the earth's surface (such as on the seabed), in which case they may be located within nodes or along cables. The seismic sensors themselves can include one or more of a number of different types of device capable of detecting an acoustic wave within the surrounding material. Nodes can also include additional sensors for measuring a node position, orientation, temperature, for location of the node, and for monitoring of other parameters.

Marine seismic surveys generally operate by towing acoustic sources behind a survey vessel so that they travel over the area to be surveyed as they are activated. The setup shown in FIG. 1 includes two source arrays 122 and 124 each including a plurality of sub-arrays 122A-C comprising one or more marine vibrators. Any number of arrays, each including any number of marine vibrators can be used, and these can be combined with seismic streamers for collecting data, with seabed nodes or cables, or with both. In the past, surveys have used impulsive sources, such as air guns, which emit acoustic waves over a very short duration. Herein, a “source” is used to refer to a radiating surface producing a sound wave in a surrounding medium. A marine vibrator can therefore include one or more sources depending on how many radiating surfaces are present.

More recently, marine vibrators have emerged as viable alternatives to air guns in this type of survey. These have a more complex structure, and operate by producing pressure waves in the surrounding water over a longer period of time, with each period over which a continuous signal is emitted by the vibrator being referred to as a sweep. The frequency and/or amplitude of the emitted signal may change during the course of the sweep. The amplitude of the emitted signal at any one time is lower than for an airgun, however, and this can reduce the environmental impact of the survey. Seismic sensors collect pressure or particle motion data representing the wavefield from an array of sources at the sensor position, and this data is processed to extract the desired information about the subsurface structure through which the acoustic waves have travelled to reach that position. In order to do so, an accurate estimate of the original acoustic signature emitted by all of the sources in the source array together is required. Interactions between waveforms emitted by different sources in the array, and inconsistencies between vibrators in terms of their physical structure, can make achieving an accurate estimate of the far-field waveform from the whole array together extremely difficult.

Inversion-based solutions for notional sources within airgun arrays using near-field pressure measurements have been discussed in Amundsen (1993) and Hargreaves et al. (2015). These methods use hydrophones located near to the source, which can be towed behind the survey vessel in a “mini-streamer” or alternatively installed just above the air guns, to estimate the near-field signature for the array. From this, a far-field signature can be inferred. This type of measurement is usable to derive a fairly accurate source signature for an airgun array, for which each source can be considered a point source and the wavefield is short-lived. WO-A-2022/225400 describes a similar method for estimating a far-field waveform for a vibrator using pressure measurements of the near-field. US-A-2014/0283615 describes the use of data from accelerometers that are directly coupled to a marine vibrator and which are used to derive a volume acceleration of the vibrator. From this measured change in volume, a source signature in the far field can be inferred, but this will not take into account the signatures from other vibrators operating nearby nor interactions with the sea-surface, and will not take into account contributions to the emitted wavefield that are not measured.

Traditional methods used to determine a source signature for sources in marine seismic surveys all have drawbacks. Methods for more accurately determining a source signature in this type of survey are desirable.

According to a first aspect of the present invention, there is provided a method for deriving at least one notional source waveform for an array comprising at least one marine vibrator, the method comprising: during operation of the at least one marine vibrator, recording data from a first sensor measuring a property related to the wavefield in the fluid surrounding the at least one marine vibrator; during operation of the at least one marine vibrator, recording data from a second sensor coupled to or internal to a radiating surface of the vibrator and measuring a property related to motion of the radiating surface; and jointly inverting the data from the first sensor and the data from the second sensor to recover the at least one notional source waveform for the array.

The method requires the collection of data from the first and second sensor for each vibrator within an array, one measuring (directly or indirectly) a property of the wavefield in the fluid surrounding the vibrator and one measuring movement of the radiating surface itself. The collected data is then entered together as part of a single inversion process to retrieve a notional source waveform, and this allows a much more accurate estimate of the waveform to be obtained than would be possible if data from only one of the sensors were to be collected, or if these were to be processed separately. Motion data for the radiating surface is closely related to the behaviour of device itself and measurements of the wavefield in the fluid surrounding the vibrator are closely related to the interaction between different devices in the array. Combining these via joint inversion gives the best possible result.

Joint inversion refers to the process of treating the data together, either as input data for a particular model, or as a vector in a matrix equation from which a set of notional source waveforms including a contribution from each source in the array can be derived. The fact that the inversion of both types of data is carried out “jointly” means that the data from the two sensor types are dealt with together and are dealt with in the same manner. This may mean that the data from the first and second sensors form a row/column vector to be operated on by a matrix as part of the inversion process. The sensor data will usually be entered together into a computational engine which will receive the data from the first and second sensors as input, as well as information about a forward model, and which will output the set of notional source waveforms in response. Selection of which computational engine to use for the inversion, and the configuration of this engine and the forward model, will depend on requirements for each particular survey and can be optimized for noise. Some ways in which the forward model can be simplified by making certain assumptions about the source wavefields emitted are set out below.

The radiating surface of the vibrator is the moving part of the structure which generates the pressure wavefield in the surrounding fluid in response to a pilot signal. In embodiments, the first sensor and second sensor are of different sensor types. There may be more than one sensor of the first type and/or more than one sensor of the second type. Reference to the second sensor being internal to the radiating surface means that the sensor is located within the vibrator housing, inward of the radiating surface. Reference to measurements being taken during operation of the vibrator is to recording data during a period in which the vibrator is being activated to produce an acoustic signal (i.e. one or more sweeps of the vibrator are ongoing). The first sensor may be positioned to measure a property of the wavefield (such as pressure) in the water close to the vibrator surface. Close may mean less than 5 meters from the surface of the vibrator. This will usually mean that the first sensor senses a near-field waveform for the vibrator with which it is associated. The first sensors together detect a near-field waveform for the array.

The method may be usable to estimate a set of one or more notional source waveforms that represent the emitted sweeps of a marine vibrator array comprising one or more vibrators. In this case the development of the waveform over time is accounted for. In embodiments, the joint inversion is carried out in the time domain. In embodiments, the joint inversion is carried out in the frequency domain. If contributions are not combined by making certain assumptions, as set out below, there will be one notional source waveform in the set for each real and for each virtual source in the array. Each vibrator will be associated with one or more source, depending on the number of radiating surfaces present. For joint inversion, the vibrators can be considered as acting as independent monopole sources or as including more than one source, such as two sources. If the latter, it can be assumed that the vibrators act as double monopole sources, wherein the two monopole sources are approximately in phase. The joint inversion can then be carried out on this basis including one notional source waveform for each vibrator, the notional source waveform including a contribution from both monopole sources.

In embodiments, the first sensor measures a property related to the wavefield in the fluid surrounding the associated vibrator that is directly or indirectly related to a pressure response caused by the activation of that vibrator. The measurements by the first and second sensors are taken during activation of the associated vibrator.

In embodiments, the method comprises positioning the first sensor to measure a property related to the wavefield in the fluid at a distance of less than 5 meters from the marine vibrator surface. This may refer to a distance of less than 5 meters from the outer (wet) surface of the marine vibrator in any direction. The first sensor may be positioned using a streamer or structure which moves with the vibrator, or may be coupled to the vibrator itself, such as by using a frame or extension (although the measurement taken will still be of pressure in the water surrounding the vibrator). The position of the first sensor relative to the vibrator will usually be fixed during a survey. Although the first sensor is located closest to the vibrator with which it is associated, it will pick up pressure changes as a result of acoustic signals emitted by any other vibrators present in the array.

In embodiments, the first sensor is a pressure sensor. The first sensor may be a hydrophone. In embodiments, the second sensor is a motion sensor. The second sensor may be an accelerometer.

In embodiments, the second sensor is a temperature sensor positioned within a housing of the vibrator for measuring temperature changes caused by movement of the radiating surface. Rather than directly measuring movement of the radiating surface, temperature changes resulting from the movement are sensed by the temperature sensor. In embodiments, the second sensor is a voltmeter configured to sense a pilot signal being sent to the vibrator. Since the pilot signal causes movement of the radiating surface of the vibrator, this also provides a way in which to indirectly measure or infer movement of the radiating surface using a sensor.

In embodiments, the array comprises a plurality of marine vibrators, each vibrator being associated with a first sensor for measuring a property related to the wavefield in the fluid surrounding that vibrator, and each having a second sensor coupled to or internal to a radiating surface of that vibrator to measure a property related to the motion of the radiating surface, and the method comprises jointly inverting the data from the first and second sensors for all vibrators in the array to recover the set of notional source waveforms. The data from first and second sensors associated with each of the sources in the array can be treated together as part of the joint inversion, the result of which can be used to provide a reliable estimate of the far-field whilst minimising complexity and processing power requirements. The joint inversion in this case will comprise entering data from all sensors, with the resulting set of notional source waveforms including contributions from all real sources in the array and optionally also each of a plurality of virtual sources associated with each real source.

In embodiments, jointly inverting the data from the first and second sensors comprises formulating an operator matrix linking the data from the first sensor and the data from the second sensor to one or more notional source waveforms and using the inverse of the operator matrix to recover the one or more notional source waveforms from the data from the first sensor and the data from the second sensor. The operator matrix may include elements which link each sensor present in the system to each source, and which account for the sensor-source distances and phase shifts in the water. The matrix elements can be calculated in any way, such as by modelling.

In embodiments, the second sensor is a motion sensor coupled to the radiating surface of the vibrator. The motion sensor will most often by fixed to the radiating surface to move with it. The motion sensor may be an accelerometer. If more than one radiating surface is present, such as in a case where the vibrator comprises two piston-driven vibrating surfaces, one at each end of an elongate vibrator body, an accelerometer or another motion sensor can be fixed to each of these. If fixed to the radiating surface, the second sensor may be external to or internal to the surface, but it may be convenient to locate this internal to the vibrator housing for greater physical protection.

In embodiments, the method comprises recording data from at least two sensors measuring a property related to the wavefield in the fluid surrounding each marine vibrator. These sensors may be of the same type, and may be pressure sensors such as hydrophones. This allows virtual sources, representing the reflected signal for each of the real sources at the water surface, to be accounted for by treating these virtual sources in the same way as the real sources during the joint inversion process. Differences between the real and virtual sources can, in such a case, be taken into account in a comprehensive way.

In embodiments, the method comprises recording data from a maximum of one first sensor associated with each vibrator and configured to measure a property related to the wavefield in the fluid surrounding each vibrator in the array. This is possible if the vibrators of the array can be treated as monopole sources (i.e. the vibrator includes a single radiating surface) and if reflections from the water surface do not need to be taken into account. This can also be the case if certain assumptions are made for the joint inversion. Virtual sources can be treated as scaled versions of the real sources with which they are associated, meaning that these can be solved together with the real sources rather than solved explicitly. This method cannot take account of differences between the virtual and real waveforms (other than a simple scaling factor), but does reduce the number of first sensors required to perform the method to one per real source. For vibrators comprising two sources (e.g. two radiating surfaces), a single first sensor can be positioned to measure the wavefield in the fluid surrounding that vibrator if the assumption is made that these surfaces can be treated as monopole sources which vibrate in phase. Therefore, if both assumptions are applied (each virtual source is a scaled version of the corresponding real source and the two radiating surfaces of each vibrator can be treated as two monopole sources vibrating in phase), one sensor per vibrator for measuring a property of the fluid surrounding that vibrator can be sufficient to apply the joint inversion method.

In embodiments, the at least one vibrator comprises a vibrator body or housing having a radiating surface on each side. The housing may be elongate, and the radiating surfaces may be located at each end of the housing. The vibrating surfaces are the moving or radiating surfaces of the vibrator whose movement results in acoustic radiation travelling outwards from the vibrator through the surrounding fluid. The radiating surfaces may be piston-driven and may vibrate more or less in phase with each other. The housing of the vibrator in this case is symmetrical, with the two ends moving in the same way to cause pressure changes in the surrounding water.

Whatever the shape of vibrator and however many radiating surfaces are present, the vibrator may be of significant size compared to the shortest wavelength of interest in the seismic survey being performed (i.e. for an elongate housing, the length of the housing is larger than or equal to one tenth of the shortest wavelength of interest in the seismic survey). The vibrating plates can in some cases be the only part of the outer surface of the vibrator which moves, making processing more straightforward and reducing the number of sensors required to achieve an accurate estimate of the notional source waveform. The joint inversion method is particularly useful when applied for a vibrator of significant size compared to the shortest wavelength of interest in the seismic survey being performed and/or a marine vibrator with a symmetrical structure and two pistons. A typical shortest wavelength of interest for a survey of the type described herein is around 15 meters. A vibrator of 1.5 meters in length or more will therefore be considered “not small” or “of significant size” compared to the shortest wavelength of interest in such a case. All sources of potential inaccuracy in a derived notional source waveform for this type of vibrator can be addressed in a simple manner. Some assumptions about the structure of the wavefield can also be used to reduce the number of sensors required to perform the method with accurate results, as set out below.

In embodiments, the method comprises treating each vibrator as two monopole sources vibrating in phase for the joint inversion. This is a suitable assumption for a vibrator of the type described above, with two driven radiating surfaces and a symmetrical configuration. This greatly simplifies the process of carrying out the joint inversion, and can mean that only one pressure measurement is required for each source. This is true even if virtual sources are accounted for in a case where these are treated as scaled versions of the equivalent real source, i.e. scaling using a reflection coefficient.

In embodiments, the method comprises, as part of the joint inversion, solving for an additional virtual source corresponding to each real source in the array. In embodiments, the method comprises solving explicitly for each virtual source as well as each real source as part of the joint inversion. A first sensor is then generally required for each source (both real and virtual), but the virtual sources can be more accurately characterized. The wavefield emitted by each real source in the array is considered to be reflected from the surface of the water and a virtual source is placed (or is given positional coordinates) matching the position of the image of the real source. This provides a simple way to account for reflected signals in cases where the sources are located near to the water surface. This is the case for most marine seismic surveys. The virtual sources are treated in the same way as the real sources during inversion, and where an operator matrix is used these simply represent additional entries in the column/row vectors and operator matrix itself.

In embodiments, the method comprises treating each virtual source as a scaled version of its corresponding real source. This assumption that the virtual and real sources are the same aside from a scaling factor means that virtual and real sources can be dealt with together as part of the joint inversion (as a compound notional source comprising a contribution from the real source and a scaled contribution from the virtual source). This reduces the required minimum number of sensors associated with an array, and in particular the number of first sensors for measuring a property of the wavefield in the fluid surrounding the vibrators, in order to be able to use the joint inversion method.

In embodiments, the method comprises weighting the data from the first sensor and/or the second sensor prior to the joint inversion. Weights for the data deriving from each sensor can be 1, 0 (data from that sensor not used), or can represent a number larger than 0 and smaller than 1 which can be configurable. The relative importance of the data in the inversion can therefore be easily adapted based on the expected reliability of the data, based on measured noise in the data, or based on other factors.

In embodiments, the weightings applied are frequency dependent. Different weightings can be applied depending on the frequency of the signal received from the sensor. This is advantageous for sensors producing a frequency dependent signal in that it allows sensors with different operating bandwidths to be used within the same array setup (a weighting of 0 can be set for the frequencies where data is not available).

The method can include a separate stage of numerical calculation for the propagation terms that describe the pressure field at a hydrophone due to a finite radiating surface and which takes account the acoustic effects due to the presence of the body of the vibrator, i.e. where the simple monopole wavefield assumption is invalid. The additional stage may comprise summing contributions from distributed point sources such as by using the Helmholtz-Kirchhoff integral method.

According to a second aspect of the present invention, there is provided a method for carrying out a seismic survey comprising: activating an array comprising at least one marine vibrator to emit a source wavefield; using seismic sensors, collecting seismic data representing the source wavefield after reflection from subsurface structure; deriving a notional source waveform using the method of the first aspect; deriving a far-field source waveform from the notional source waveform; and processing the seismic data using the derived far-field source waveform to retrieve information about the subsurface structure.

According to a third aspect of the present invention, there is provided a seismic survey apparatus comprising: at least one marine vibrator for emitting a source wavefield; a set of seismic sensors for collecting seismic data representing the source wavefield after reflection from subsurface structure; at least one first sensor positioned to measure a property related to the source wavefield in the fluid surrounding the at least one marine vibrator during activation of the vibrator; at least one second sensor coupled to or positioned internal to a radiating surface of the vibrator to measure motion of the radiating surface of the at least one marine vibrator during activation of the vibrator; a processor configured to receive data from the at least one first sensor and data from the at least one second sensor, and to jointly invert the data from the first and second sensors to recover a set of at least one notional source waveform for the marine vibrator array.

In embodiments, the processor is configured to: derive a far-field source waveform from the at least one notional source waveform; and process the seismic data using the derived far-field source waveform to retrieve information about the subsurface structure.

In embodiments, the processor is configured to jointly invert the data from the first and second sensors by formulating an operator matrix linking the data from the first sensor and the data from the second sensor to the at least one notional source waveform and using the inverse of the operator matrix to recover the at least one notional source waveform from the data from the first sensor and the data from the second sensor.

Embodiments of the present invention will now be described, by way of example only, with reference to the following diagrams wherein:

FIG. 1 illustrates a possible set-up for a marine seismic survey;

FIG. 2 shows the positions of sources, first sensors, and second sensors in one configuration of the array where sources are treated as monopole sources; and

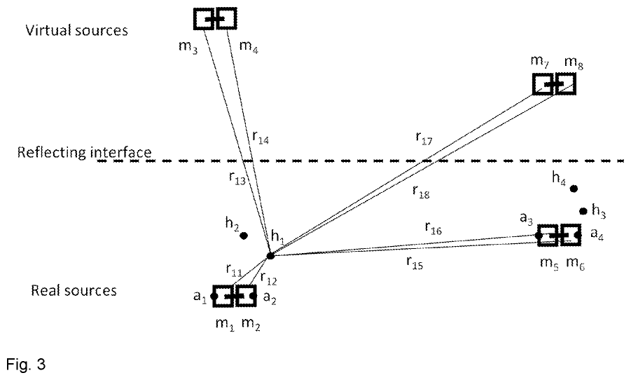

FIG. 3 shows the positions of sources, first sensors, and second sensors in another configuration of the array where sources are treated as double monopole sources.

The joint inversion method described herein combines different measurements made in the vicinity of one or more acoustic sources, which may represent a plurality of sources arranged as an array. The measurement and subsequent processing using the measured data is carried out in such a way as to overcome many of the issues with current methods for estimating a source signature for geological surveys, and particularly for marine geological surveys using one or more marine vibrators as the sources.

For marine vibrators, the input pilot signal used to drive the vibration is not always an accurate representation of the wavefield emitted in the water, and the advantage of including outboard measurements, such as measurements from hydrophones located in the water close to a vibrator, as well as onboard measurements, such as measurements from a motion sensor, is to provide a much more accurate estimate of the signal emitted into the far-field. The processing of the measurements together by jointly inverting allows the data from different sensor types to be used together in the most effective way to provide the best possible estimate of the notional source waveform. This joint inversion method is particularly suitable in cases where the acoustic energy is emitted by driving one or more vibrating surfaces, and allows any distortions in the wavefield and interactions with nearby interfaces to be accounted for.

The method requires that one or more first sensors be positioned and configured to measure a property related to the wavefield in the surrounding fluid close to the sources (i.e. pressure) and that one or more second sensors be positioned and configured to measure a property related to the movement of one or more vibrating parts of the vibrator itself (i.e. acceleration). The first sensors need not be coupled to the vibrator or array, but can be located on a streamer, on a frame coupled to the source array or to the vibrator, or on another structure located near to the array during the survey. The second sensors must be usable to detect or infer movement of the vibrator housing itself, and so will usually be directly coupled or attached to the vibrating parts of the housing. Suitable sensors for use as the first sensors are hydrophones for measuring pressure changes in the water close to the sources (i.e. the near-field pressure component of the emitted wavefield). Suitable sensors for use as the second sensors are accelerometers for measuring an acceleration of the vibrating surfaces. These measurements can be inverted jointly to solve for a set of real notional source signatures, which are then used to construct a reliable estimate of the far-field signature for the source, including the array response and any transducer-related distortion and reflection from nearby interfaces. Both sets of measurements have limitations and are subject to noise. However, when the measurements are combined in a joint inversion as described herein, such as a least-squares inversion, they offer the best opportunity to obtain a robust estimate of the complete source signature in the far field.

In order to take account of reflections from a nearby boundary, such as the surface of the water, the joint inversion method can be used to solve also for a number of virtual sources, each representing the reflected signal from a real source in the array. Certain assumptions can simplify the treatment of these virtual sources. For example, they can be assumed to emit the same signal as the corresponding real source but scaled using reflection coefficients to account for energy losses at the reflection boundary.

The joint inversion method is particularly suitable for use with an array of marine vibrators having dimensions that are not small compared to the shortest wavelength of interest in the seismic survey to be completed (largest dimension at least one tenth of the size of the shortest wavelength of interest), and which have a fairly simple structure which changes shape in a predictable way during emission of a signal. The array in question may, for example, be made up of a plurality of marine vibrators having one, two, or more rigid or semi-rigid surfaces which reciprocate to create a pressure wave in the surrounding fluid. These are the moving or radiating surfaces of the vibrator, and each represents a real source. The surfaces may be driven by electro-hydraulic actuators, piezoelectric actuators, or in any other way. The reciprocating surfaces may be located on the end of pistons, and there may be two pistons driving two vibrating surfaces in opposite directions at either end of the vibrator. The vibrator will therefore lengthen and shorten as the pistons move in and out over the course of a sweep. Rubber components may surround the end surfaces of the vibrator, which can in principle complicate the emitted signal and make this more difficult to predict from the pilot signal alone.

For this type of vibrator, measurements of the pressure field in the water alone will not provide an accurate representation of the far-field (as it can do in the case of airgun arrays). Measurements of the movement of the vibrator surface will also not allow accurate representation of the notional source to be derived, due to local resonances or imperfections in the vibrator housing. The joint inversion method, described in detail below, can be used to mitigate issues with both types of measurement, and is associated with particular advantages as discussed herein.

In connection with FIG. 2, the joint inversion method is described in a situation in which two real sources and two virtual sources are present, and where the first sensors are hydrophones and the second sensors are accelerometers. The virtual sources each represent a part of the waveform that is emitted by one of the real sources and is reflected from the surface of the water. The same method can be used for an array containing any number of real sources, with or without equivalent virtual sources, and the number of measurements from first and second sensors can be adjusted accordingly. Preferably, motion sensors (in this case representing the second sensors) should be coupled to each vibrator in the array, and pressure sensors (in this case representing the first sensors) should be located near to each vibrator to measure a waveform in the water close to that vibrator, typically less than 5 meters from the closest point on the vibrator surface. The length of the left-hand and right-hand vectors in the matrix equation below (representing the hydrophone and accelerometer data and notional source signatures/waveforms respectively) can be adapted depending on the data available and the number of sources, with the size of the matrix operator adjusted to correspond. Where other types of sensors are used as the first and second sensors, rather than hydrophones and accelerometers, the forward model will need to be adapted to properly link the data to the set of notional source waveforms to be output. In the examples described below with reference to FIGS. 2 and 3, this will mean adaption of the elements of the operator matrix.

FIG. 2 shows an example of a survey set-up in which the array comprises two separated monopole sources (i.e. each can be a vibrator with a simple piston operated end plate). Each source is instrumented with one accelerometer and two near-field hydrophones, and is located in close proximity to an air-water interface which gives rise to a ghost response from each source at mirror locations. These are referred to as virtual sources, as mentioned above, and are shown as sources m₃ and m₄ in FIG. 2. For each angular frequency ω, the forward model is posed as a matrix equation, including two vectors and an operator matrix, as follows:

$$( \begin{matrix}{h}_{1} \\ {h}_{2} \\ {h}_{3} \\ {h}_{4} \\ {a}_{1} \\ {a}_{2}\end{matrix} ) = ( \begin{matrix}{g}_{11} & {g}_{12} & {g}_{13} & {g}_{14} \\ {g}_{21} & {g}_{22} & {g}_{23} & {g}_{24} \\ {g}_{31} & {g}_{32} & {g}_{33} & {g}_{34} \\ {g}_{41} & {g}_{42} & {g}_{43} & {g}_{44} \\ {f}_{11} & 0 & 0 & 0 \\ 0 & {f}_{22} & 0 & 0\end{matrix} ) ( \begin{matrix}{m}_{1} \\ {m}_{2} \\ {m}_{3} \\ {m}_{4}\end{matrix} )$$

where hᵢ represents the data from hydrophone i, aᵢ represents the data from accelerometer i, mⱼ are the notional source waveforms (including two real and two virtual sources in this case), gᵢⱼ is an element of the upper part of the matrix operator which is concerned with propagation from the jth source to the ith hydrophone with a term for geometric scaling for the distance between them rᵢⱼ and a phase shift (based on this distance and v, the sound speed in water), and fj is an element of the lower part of the operator which converts the pressure notional signature to acceleration for a vibrating surface with piston area A. For this simple case where the radiated acoustic field from each vibrating piston can be described by a simple monopole and is unmodified by the presence of the vibrator body, these terms are given as:

$${g}_{ij} = \frac{{e}^{- j ω ( {r}_{ij} - 1 ) / v}}{{r}_{ij}} and {f}_{ij ( i = j )} = \frac{4 π}{ρ A} {e}^{j ω / v}$$

In a more general case, in order to take account of the finite source extent and the effect upon the acoustic wavefield of the presence of the vibrator body, the coefficients gᵢⱼ that describe the measured pressure at a given hydrophone due to a given source element can be calculated via a modelling approach such as the Helmholtz-Kirchhoff integral method or utilizing a finite difference numerical model for each sensor position. These methods may modify or replace completely the simple monopole term.

The fᵢⱼ terms given for the accelerometers still hold for the general case and are as above, but can still be adapted if desired for a more complex relationship between the measurement and notional source. The zero terms in the operator relate to the acceleration measurements for i≠j and are due to the fact that the accelerometers only measure the output from the source they are attached to. This is true particularly in the case of a high impedance driver.

The compound linear operator can be summarized as below:

$$( \begin{matrix}h \\ a\end{matrix} ) = ( \begin{matrix}g \\ f\end{matrix} ) m$$

It is possible to invert for the real and virtual notional sources, m, using any method. The inversion is, however, carried out jointly, meaning that pressure and accelerometer data is used as input data for a model with the notional source waveform for each of the sources as the output. Inversion allows the hydrophone and accelerometer data to be used to derive a notional wavefield vector including a contribution from all of the sources. Once notional source waveforms are known, they can be used to calculate the far-field wavefield, with the same method routinely used for airgun array sources. As an example, a suitable method may be to use an iterative solver such as LSQR (iterating to find the wavefield which minimises the difference between the predicted data and the measured data). Note that here the problem is set up in the frequency domain, but the problem can equivalently be posed in the time domain. Sensitivity to noise when inverting for virtual notional sources depends strongly on the separation between the hydrophone and the virtual source, so that the use of a ghost model or a hybrid methodology can be preferred in practice in particular when the distance between the sources and the surface of the water is larger. For example, at low frequencies a simple mirror-like ghost model, assuming that a dipole source can be sufficiently represented as two dipole sources that are in phase, may represent the physics of reflection with sufficient accuracy, while at higher frequencies, perturbations of the ghost due to non-linear effects and/or interaction with a rough and dynamic surface profile may be better captured by solving explicitly for virtual notional sources, meaning that the virtual sources are treated in a similar manner to the real sources during the joint inversion and are solved separately (matrix equation above).

If using a ghost model, the virtual sources can be expressed as reflected (and scaled) versions of the real sources, meaning that it is possible to solve only for the unknown real notional source. In the example shown in FIG. 2 with two real sources, because of the fact that the virtual source is a mirror image of the real source, the terms in the third column of the operator matrix can be combined with those in the first, and the second with the fourth, invoking an interface reflection coefficient, r. If this is done, the modified matrix equation is as follows:

$$( \begin{matrix}{h}_{1} \\ {h}_{2} \\ {h}_{3} \\ {h}_{4} \\ {a}_{1} \\ {a}_{2}\end{matrix} ) = ( \begin{matrix}{g}_{11} + r \cdot {g}_{13} & {g}_{12} + r \cdot {g}_{14} \\ {g}_{21} + r \cdot {g}_{23} & {g}_{22} + r \cdot {g}_{24} \\ {g}_{31} + r \cdot {g}_{33} & {g}_{32} + r \cdot {g}_{34} \\ {g}_{41} + r \cdot {g}_{43} & {g}_{42} + r \cdot {g}_{44} \\ {f}_{11} & 0 \\ 0 & {f}_{22}\end{matrix} ) ( \begin{matrix}{m}_{1} \\ {m}_{2}\end{matrix} )$$

This method of combining terms for real and virtual sources can be applied for any number of real sources in a similar manner. This simplification method, applying assumptions about the behaviour of the virtual sources to reduce the size of the operator matrix for the joint inversion, reduces processing power required to determine the notional source waveforms and can reduce the required number of pressure and motion sensors required to achieve an accurate result. One pressure sensor for each real source can be sufficient, for example, rather than including two pressure sensors as shown in FIG. 2.

The above joint inversion method can also easily be extended to source types where the mechanism is represented more closely by a double piston (each instrumented) through modelling the unit as two separated monopoles. An example of such a setup is shown in FIG. 3.

If solving for each monopole separately we would have the following forward model:

$$( \begin{matrix}{h}_{1} \\ {h}_{2} \\ {h}_{3} \\ {h}_{4} \\ {a}_{1} \\ {a}_{2} \\ {a}_{3} \\ {a}_{4}\end{matrix} ) = ( \begin{matrix}{g}_{11} & {g}_{12} & {g}_{13} & {g}_{14} & {g}_{15} & {g}_{16} & {g}_{17} & {g}_{18} \\ {g}_{21} & {g}_{22} & {g}_{23} & {g}_{24} & {g}_{25} & {g}_{26} & {g}_{27} & {g}_{28} \\ {g}_{31} & {g}_{32} & {g}_{33} & {g}_{34} & {g}_{35} & {g}_{36} & {g}_{37} & {g}_{38} \\ {g}_{41} & {g}_{42} & {g}_{43} & {g}_{44} & {g}_{45} & {g}_{46} & {g}_{47} & {g}_{48} \\ {f}_{11} & 0 & 0 & 0 & 0 & 0 & 0 & 0 \\ 0 & {f}_{22} & 0 & 0 & 0 & 0 & 0 & 0 \\ 0 & 0 & 0 & 0 & {f}_{35} & 0 & 0 & 0 \\ 0 & 0 & 0 & 0 & 0 & {f}_{46} & 0 & 0\end{matrix} ) ( \begin{matrix}{m}_{1} \\ {m}_{2} \\ {m}_{3} \\ {m}_{4} \\ {m}_{5} \\ {m}_{6} \\ {m}_{7} \\ {m}_{8}\end{matrix} )$$

If the double monopole sources are coupled and in phase, then an average measurement and response might be more appropriate, and this then makes it possible to solve only for the monopole contribution by making the assumption that the wavefield for each of the monopole sources are the same, i.e. that m₁=m₂ and m₃=m₄ and m₅=me and m₇=me. Propagation terms can then be combined while still preserving the true distances to each of the coupled elements but posed to solve for a smaller number of unknowns:

$$( \begin{matrix}{h}_{1} \\ {h}_{2} \\ {h}_{3} \\ {h}_{4} \\ ( {a}_{1} + {a}_{2} ) / 2 \\ ( {a}_{3} + {a}_{4} ) / 2\end{matrix} ) = ( \begin{matrix}{g}_{11} + {g}_{12} & {g}_{13} + {g}_{14} & {g}_{15} + {g}_{16} & {g}_{17} + {g}_{18} \\ {g}_{21} + {g}_{22} & {g}_{23} + {g}_{24} & {g}_{25} + {g}_{26} & {g}_{27} + {g}_{28} \\ {g}_{31} + {g}_{32} & {g}_{33} + {g}_{34} & {g}_{35} + {g}_{36} & {g}_{37} + {g}_{38} \\ {g}_{41} + {g}_{42} & {g}_{43} + {g}_{44} & {g}_{45} + {g}_{46} & {g}_{47} + {g}_{48} \\ {f}_{11} & 0 & 0 & 0 \\ 0 & 0 & {f}_{35} & 0\end{matrix} ) ( \begin{matrix}{m}_{1} \\ {m}_{3} \\ {m}_{5} \\ {m}_{7}\end{matrix} )$$

Again, this combination method can be applied similarly for arrays with different numbers of vibrators by considering at least some of the vibrators as two similar monopole sources that are in phase. This can be simplified further to solve for just two unknowns if a ghost model is used, as before:

$$( \begin{matrix}{h}_{1} \\ {h}_{2} \\ {h}_{3} \\ {h}_{4} \\ ( {a}_{1} + {a}_{2} ) / 2 \\ ( {a}_{3} + {a}_{4} ) / 2\end{matrix} ) = ( \begin{matrix}{g}_{11} + {g}_{12} + r ( {g}_{13} + {g}_{14} ) & {g}_{15} + {g}_{16} + r ( {g}_{17} + {g}_{18} ) \\ {g}_{21} + {g}_{22} + r ( {g}_{23} + {g}_{24} ) & {g}_{25} + {g}_{26} + r ( {g}_{27} + {g}_{28} ) \\ {g}_{31} + {g}_{32} + r ( {g}_{33} + {g}_{34} ) & {g}_{35} + {g}_{36} + r ( {g}_{37} + {g}_{38} ) \\ {g}_{41} + {g}_{42} + r ( {g}_{43} + {g}_{44} ) & {g}_{45} + {g}_{46} + r ( {g}_{47} + {g}_{48} ) \\ {f}_{11} & 0 \\ 0 & {f}_{35}\end{matrix} ) ( \begin{matrix}{m}_{1} \\ {m}_{5}\end{matrix} )$$

When virtual sources are ignored, the number of first sensors required to achieve an accurate estimate of the source wavefield can be halved by treating dipole sources as two monopole sources vibrating in phase if it is assumed that the two monopole terms for a dipole source are equal, as set out above. This will be the case for vibrators having a more or less symmetrical shape (i.e. two similar vibrating surfaces at each end). This simplifies both the method and the survey set-up. More first sensor measurements (in this case hydrophone measurements) can obviously be used if desired, but this is not a requirement in such a case. In general, the total number of sensors (i.e. hydrophones plus accelerometers) needs to be equal or greater than the number of marine vibrators in the array. A greater number of sensors is beneficial for the reasons discussed earlier.

As mentioned, although the specific examples use hydrophones as the first sensors and accelerometers as the second sensors other types of sensors can be used in place of these to measure properties relating to the wavefield in the fluid close to the vibrator and the movement of the radiating surface (e.g. temperature sensors, piezoelectric sensors, voltmeters). This will require only adaption of the forward model, and specifically of the elements of the operator matrix, to account for the change and to properly link the data with the waveforms produced by the sources.

For any of the examples set out above, weighting factors can be introduced to weight the contribution of the data from one, some, or all of the sensors present to the output set of one or more notional wavefield. These can represent a fixed number (i.e. 0, 1, or any number in between) or can represent a function in which case the weight can be allowed to vary with frequency, time, angle, and so on as desired. The weight or the weighting function can be introduced to the left-hand vector in the matrix equations shown above as a multiplier for each of the elements representing the sensor data. Including weighting factors allows account to be taken of the reliability of the data. Weights can depend on a measured noise in the sensor data, for example, or on an expected reliability of the sensor. Including the option of a 0 weight can also allow defunct sensors to be dealt with in a simple way. Frequency dependence of the weighting functions can be useful in that sensors having different sensitivity ranges and with different frequency responses can be easily introduced as part of the apparatus, resulting in an extremely flexible setup.

The above methods can be applied to arrays comprising more than one different vibrator type. Some vibrators in the array can be treated as monopole sources, for example, and some as dipole sources.

1. A method for deriving at least one notional source waveform for an array comprising at least one marine vibrator, the method comprising:
during operation of the at least one marine vibrator, recording data from a first sensor measuring a property related to the wavefield in the fluid surrounding the at least one marine vibrator;
during operation of the at least one marine vibrator, recording data from a second sensor coupled to or internal to a radiating surface of the vibrator and measuring a property related to motion of the radiating surface; and
jointly inverting the data from the first sensor and the data from the second sensor to recover the at least one notional source waveform for the array.

2. The method of claim 1, comprising positioning the first sensor to measure a property related to the wavefield in the fluid at a distance of less than 5 meters from the marine vibrator surface.

3. The method of claim 1, wherein the first sensor is a pressure sensor.

4. The method of claim 1, wherein the second sensor is a motion sensor.

5. The method of claim 4, wherein the second sensor is a temperature sensor positioned within a housing of the vibrator for measuring temperature changes caused by movement of the radiating surface.

6. The method of claim 1, wherein the array comprises a plurality of marine vibrators, each vibrator being associated with a first sensor for measuring a property related to the wavefield in the fluid surrounding that vibrator, and each having a second sensor coupled to or internal to a radiating surface of that vibrator to measure a property related to the motion of the radiating surface, and the method comprises jointly inverting the data from the first and second sensors for all vibrators in the array to recover a set of notional source waveforms.

7. The method of claim 1, wherein jointly inverting the data from the first and second sensors comprises formulating an operator matrix linking the data from the first sensor and the data from the second sensor to the at least one notional source waveform and using the inverse of the operator matrix to recover the at least one notional source waveform from the data from the first sensor and the data from the second sensor.

8. The method of claim 1, wherein the second sensor is a motion sensor coupled to the radiating surface of the vibrator.

9. The method of claim 1, wherein the at least one vibrator comprises a vibrator body having a radiating surface on each side.

10. The method of claim 9, wherein the method comprises treating each vibrator as two monopole sources vibrating in phase for the joint inversion.

11. The method of claim 1, wherein the method comprises, as part of the joint inversion, solving for an additional virtual source corresponding to each real source in the array.

12. The method of claim 11, comprising treating each virtual source as a scaled version of its corresponding real source.

13. The method of claim 11, comprising solving explicitly for each virtual source as well as each real source as part of the joint inversion.

14. The method of claim 1, comprising weighting the data from the first sensor and the second sensor prior to the joint inversion.

15. The method of claim 14, wherein the weightings applied are frequency dependent.

16. A method for carrying out a seismic survey comprising:
activating an array comprising at least one marine vibrator to emit a source wavefield;
using seismic sensors, collecting seismic data representing the source wavefield after reflection from subsurface structure;
deriving a notional source waveform using the method of claim 1;
deriving a far-field source waveform from the notional source waveform; and
processing the seismic data using the derived far-field source waveform to retrieve information about the subsurface structure.

17. A seismic survey apparatus, comprising:
an array comprising at least one marine vibrator for emitting a source wavefield;
a set of seismic sensors for collecting seismic data representing the source wavefield after reflection from subsurface structure;
a first sensor positioned to measure a property related to the source wavefield in the fluid surrounding the at least one marine vibrator during activation of the vibrator;
a second sensor coupled to or internal to a radiating surface of the vibrator to measure motion of the radiating surface of the at least one marine vibrator during activation of the vibrator;
a processor configured to receive data from the first sensor and data from the second sensor, and to jointly invert the data from the first and second sensors to recover one or more notional source waveforms for the marine vibrator array.

18. The apparatus of claim 17, wherein the processor is configured to:
derive a far-field source waveform from the one or more notional source waveforms; and
process the seismic data using the derived far-field source waveform to retrieve information about the subsurface structure.

19. The apparatus of claim 17, wherein the processor is configured to jointly invert the data from the first and second sensors by formulating an operator matrix linking the data from the first sensor and the data from the second sensor to the at least one notional source waveform and using the inverse of the operator matrix to recover the at least one notional source waveform from the data from the first sensor and the data from the second sensor.
